(19) United States
(12) Patent Application Publication
(10) Pub. No.: US 2014/0143459 A1
(43) Pub. Date: May 22, 2014

(54) MOBILE DEVICE AND USB HUB

(71) Applicant: SAMSUNG ELECTRONICS CO., LTD., Suwon-si (KR)

(72) Inventor: SEUNG-SOO YANG, Hwaseong-si (KR)

(73) Assignee: SAMSUNG ELECTRONICS CO., LTD., Suwon-si (KR)

(21) Appl. No.: 14/072,353

(22) Filed: Nov. 5, 2013

(30) Foreign Application Priority Data
Nov. 21, 2012 (KR) 10-2012-0132136

(51) Int. Cl. G06F 13/12

(52) U.S. Cl. CPC G06F 13/122
USPC 710/60

(57) ABSTRACT

A mobile device includes a first function, a second function and a first universal serial bus (USB) port. The first function and the second function are respectively associated with a first host controller driver and a second host controller driver in a host. A composite USB cable connects the first host controller driver and at least a second host controller driver of the host and the mobile device and simultaneously provides a USB interconnection to the first and second functions therethrough depending upon whether a first USB identifier (ID) of the first function and a second USB ID of the second function are identical to each other.

### CROSS-REFERENCE TO RELATED APPLICATIONS

This application claims priority under 35 USC §119 to Korean Patent Application No. 10-2012-0132136, filed on Nov. 21, 2012, the disclosure of which is incorporated by reference in its entirety.

### TECHNICAL FIELD

Exemplary embodiments of the present inventive concept relate to a mobile device, and more particularly, to a mobile device and a universal serial bus (USB) hub.

### DISCUSSION OF THE RELATED ART

USB is a standard interface that enables various peripheral devices to be connected to a host device. A composite USB device may provide a plurality of USB functions such as mode, interface and object exchange. The USB 3.0 specification has recently been released and is gaining in popularity. The USB 3.0 specification provides for a transfer mode known as “SuperSpeed” which may perform up to ten times faster than is capable under the USB 2.0 specification. The USB 3.0 specification maintains backward compatibility with USB 2.0 by providing both a SuperSpeed bus as well as a standard USB 2.0 bus. Where both host and device are USB 3.0 capable, the SuperSpeed bus is used. Where at least one of the host and device are not USB 3.0 capable, the USB 2.0 bus is used.

### SUMMARY

Exemplary embodiments of the inventive concept provide a mobile device capable of increasing bus utilization.

Exemplary embodiments of the inventive concept provide a USB hub capable of increasing bus utilization.

According to an exemplary embodiment, a mobile device includes a first function, a second function and a first universal serial bus (USB) port. The first function and the second function are respectively associated with a first host controller driver and a second host controller driver in a host. A composite USB cable connects the first host controller driver and at least a second host controller driver of the host and the mobile device and simultaneously provides a USB interconnection to the first and second functions therethrough depending upon whether a first USB identifier (ID) of the first function and a second USB ID of the second function are identical to each other.

In an exemplary embodiment, the composite USB cable may include a first data channel that provides a USB connection between the first function and the first host controller driver having a first speed and a second data channel that provides a USB connection between the second function and the second host controller driver having a second speed that is greater than the first speed.

The composite USB cable may be connected to the first and second host controller drivers through a single USB port of the host.

The composite USB cable may be connected to the first and second host controller drivers through two USB ports of the host.

In an exemplary embodiment, the mobile device may include a first chip that performs the first function and a second chip that performs the second function.

The first chip may perform the first function. A first device controller driver provides the first function to the host. A first physical layer (PHY) is connected to the first device controller driver. A second PHY is connected to the first device controller driver. The second chip may perform the second function. A second device controller driver provides the second function to the host. A third PHY is connected to the second device controller driver. A fourth PHY is connected to the second device controller driver.

The first PHY may be connected to the first data channel when the first function is enabled in the first chip. The fourth PHY is connected to the second data channel when the second function is enabled in the second chip.

In an exemplary embodiment, the mobile device may include one chip that provides both the first function and the second function.

The one chip may further include a first device controller driver that provides the first function to the host. A first physical layer (PHY) connects the first device controller driver to the first data channel. A second device controller driver provides the second function to the host. A second PHY connects the second device controller driver to the second data channel.

The one chip may further include a first function driver that drives the first function. A first device driver is connected to the first function driver. A second function driver drives the second function. A second device driver is connected to the second function driver. A device controller driver is connected to the first and second device drivers, which provide the first function and the second function to the host. A first physical layer (PHY) connects the device controller driver to the first data channel. A second PHY connects the device controller driver to the second data channel.

In an exemplary embodiment, the first function is a multi-media function or a mass storage function and the second function is a modem function or a human interface device function.

According to an exemplary embodiment, a universal serial bus (USB) hub includes a first hub portion and a second hub portion. The first hub portion provides a first electrical interface, having a first speed, between a first function of a mobile device and a first host controller driver of a host. The second hub portion provides a second electrical interface, having a second speed, between a second function of the mobile device and a second host controller driver of the host. The USB hub is respectively connected to the host and the mobile device through a first USB cable and a second USB cable. The USB hub simultaneously provides the first and second electrical interfaces depending upon whether a first USB identity (ID) of the first function and a second USB ID of the second function are identical to each other.

In an exemplary embodiment, the first hub portion may include a hub repeater/forwarder configured to manage connection between downstream ports operating with the first speed and an upstream port. A hub controller may be configured to control communication with the host.

In an exemplary embodiment, the first composite USB cable may include a first data channel that provides a USB connection between the first host controller driver and the first hub portion at the first speed through an upstream port of the USB hub. A second data channel provides a USB connection between the second host controller driver and the second hub portion at the second speed through the upstream port of the USB hub. The second USB composite cable may include a third data channel that provides a USB connection between the first function and the first hub portion at the first speed through at least one of the downstream ports of the USB hub. A fourth data channel provides a USB connection between the second function and the second hub portion at the second speed through at least one of the downstream ports of the USB hub.

In an exemplary embodiment, the second composite USB cable may be respectively connected to the first and second hub portions through one or two of a plurality of downstream ports of the USB hub.

Accordingly, a SuperSpeed connection and non-SuperSpeed connection are simultaneously provided between the host and the mobile device using first and second data channels of the composite USB cable. As a result, bus utilization of the USB system may be increased.

A method for communicating data across a universal serial bus (USB) connection includes determining whether a first functional element capable of communicating over a USB 3.0 SuperSpeed connection within a mobile device and a second functional element within a mobile device have an identical USB ID. When it is determined that the first functional element and the second functional element do not have identical USB IDs, a USB 3.0 SuperSpeed connection is established between the first functional element of the mobile device and a first host controller driver of the host and a concurrent non-SuperSpeed connection is established between the second functional element of the mobile device and a second host controller driver of the host. The USB 3.0 SuperSpeed connection and the concurrent non-SuperSpeed connection utilize a common composite USB cable.

### BRIEF DESCRIPTION OF THE DRAWINGS

The above and other features of the present inventive concept will become more apparent by describing in detail exemplary embodiments thereof with reference to the accompanying drawings, in which:

FIG. 1 is a block diagram illustrating a USB system including a mobile device according to an exemplary embodiment of the present inventive concept;

FIG. 2 is a block diagram illustrating a USB system according to an exemplary embodiment of the present inventive concept;

FIG. 3 is a block diagram illustrating an example of the mobile device in FIG. 1 according to an exemplary embodiment of the present inventive concept;

FIG. 4 is a block diagram illustrating an example of the mobile device in FIG. 1 according to an exemplary embodiment of the present inventive concept;

FIG. 5 is a block diagram illustrating an example of the mobile device in FIG. 1 according to an exemplary embodiment of the present inventive concept;

FIG. 6A illustrates an electrical configuration of the composite USB cable in FIG. 1 according to an exemplary embodiment of the present inventive concept;

FIG. 6B illustrates a configuration of Y-shaped USB cable according to an exemplary embodiment of the present inventive concept;

FIG. 7 is a block diagram illustrating an example of a USB system including a USB hub according to an exemplary embodiment of the present inventive concept;

FIG. 8 is a block diagram illustrating an example of a USB system including a USB hub according to an exemplary embodiment of the present inventive concept;

FIG. 9 is a block diagram illustrating the first hub portion in FIG. 7 according to an exemplary embodiment of the present inventive concept;

FIG. 10 is a block diagram illustrating an example of the second hub portion in FIG. 7 according to an exemplary embodiment of the present inventive concept;

FIGS. 11 through 14 illustrate examples of packets used in SuperSpeed transaction that occurs between the host and the mobile device of the present inventive concept;

FIG. 15 is a flow chart illustrating a connection method of a USB system according to an exemplary embodiment of the present inventive concept;

FIG. 16 is a block diagram illustrating an example of a USB system according to an exemplary embodiment of the present inventive concept;

FIG. 17 is a block diagram illustrating an example of a USB system according to an exemplary embodiment of the present inventive concept;

FIG. 18 is a block diagram illustrating a configuration of the WUSB interface of FIG. 17 according to an exemplary embodiment of the present inventive concept;

FIG. 19 is a block diagram illustrating an example of a USB system according to an exemplary embodiment of the present inventive concept; and

FIG. 20 is a block diagram illustrating an example of a USB system according to an exemplary embodiment of the present inventive concept.

### DETAILED DESCRIPTION OF THE EXEMPLARY EMBODIMENTS

Various exemplary embodiments will be described more fully hereinafter with reference to the accompanying drawings, in which some exemplary embodiments are shown. Like reference numerals may refer to like elements throughout the accompanying drawings. The present inventive concept may, however, be embodied in many different forms and should not be construed as limited to the exemplary embodiments set forth herein. The embodiments discussed herein are merely exemplary and many implementations and variations are possible. While the disclosure provides details of alternative examples, such listing of alternatives is not exhaustive.

It will be understood that, although the terms first, second, third etc. may be used herein to describe various elements, these elements should not be limited by these terms. These terms are used to distinguish one element from another. Thus, a first element discussed below could be termed a second element without departing from the teachings of the present inventive concept.

It will be understood that when an element is referred to as being “connected” or “coupled” to another element, it can be directly connected or coupled to the other element or intervening elements may be present.

USB 3.0 defines two parallel and independent USB busses in the same connection cable. The first bus is a standard USB 2.0 bus, which remains unchanged to provide for backward compatibility. The standard USB 2.0 bus offers “Low Speed” (1.5 Mb/s), “Full-speed” (12 Mb/s) and “High Speed” (480 Mb/s) protocols. The second bus, which is unique to USB 3.0, is referred to as “SuperSpeed” USB. These two busses operate substantially independently, except that operation of the busses to a given USB device is mutually exclusive. Where a SuperSpeed connection is possible, the USB 2.0 bus is disconnected to that device.

Furthermore, SuperSpeed USB has a different architecture from that of the USB 2.0 bus. Very high-speed communication systems consume large amount of power owing to high bit rates. A design requirement of SuperSpeed USB was lower power consumption, to extend the battery life of user devices. Therefore, SuperSpeed is not a broadcast bus, but rather directs communication packets to a specific node in the system and shuts down communication on idle links.

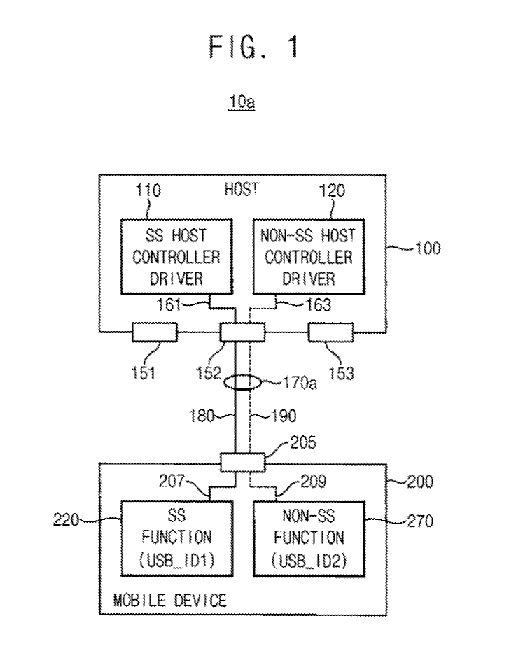

FIG. 1 is a block diagram illustrating a USB system including a mobile device according to an exemplary embodiment of the inventive concept.

Referring to FIG. 1, a USB system 10a includes a host 100, a mobile device 200 and a composite USB cable 170a that connects the host 100 and the mobile device 200 to each other.

The host 100 includes a first (SuperSpeed) host controller driver 110, a second (non-SuperSpeed) host controller driver 120 and a plurality of USB ports 151, 152 and 153. The mobile device 200 may include a first USB function 220 (or a first functional element 220 providing a first USB function), a second USB function 270 (or a second functional element 270 providing a second USB function) and a USB port 205. The first USB function 220 may be a SuperSpeed USB function, and a second USB function 270 may be a non-SuperSpeed USB function (or a SuperSpeed USB function that can be run as a non-SuperSpeed USB function). The SuperSpeed USB function 220 has a first USB identifier (ID) USB_ID1 and the non-SuperSpeed USB function 270 has a second USB ID USB_ID2. The composite USB cable 170a may include a first data channel 180 and a second data channel 190. The host 100 and the mobile device 200 may exchange data having a first speed e.g., SuperSpeed (5 Gbp/s). The host 100 and the mobile device 200 may exchange data having a second speed e.g., non-SuperSpeed (480 Mbp/s). The first data channel 180 establishes a USB connection between the host 100 and the mobile device 200 with the first speed and the second data channel establishes a USB connection between the host 100 and the mobile device 200 with the second speed. The first speed is greater than the second speed.

The first host controller driver 110 is connected to the first data channel 180 through a SuperSpeed bus 161, and the SuperSpeed function 220 is connected to the first data channel 180 through a SuperSpeed bus 207. The second host controller driver 120 is connected to the second data channel 190 through a non-SuperSpeed bus 163, and the non-SuperSpeed function 270 is connected to the second data channel 190 through a non-SuperSpeed bus 209. For example, the SuperSpeed function 220 may include a portable storage device and camera, which may seek to transmit very large files such as multi-media files. In addition, the non-SuperSpeed function 270 may include a USB function such as modem and printer human interface device (HID), which do not require large amounts of data to be transferred.

The mobile device 200 simultaneously provides the host 100 with a USB interconnection of the first and second functions 220 and 270 based on whether the first USB ID USB_ID1 the second USB ID USB_ID2 are identical to each other. For example, the mobile device 200 provides the host 100 with a USB interconnection of one of the first and second functions 220 and 270 when the first USB ID USB_ID1 the second USB ID USB_ID2 are identical to each other. The composite USB cable 170a is connected to the first and second host controller drivers 110 and 120 through the USB port 152 of the USB ports 151, 152 and 153.

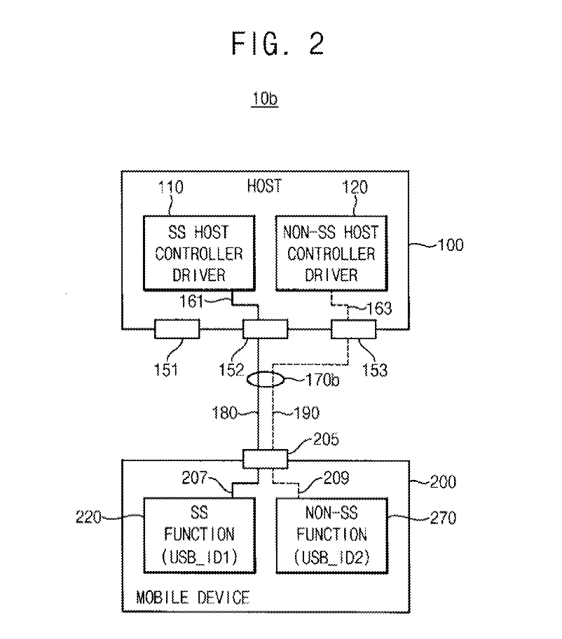

FIG. 2 is a block diagram illustrating a USB system according to an exemplary embodiment.

Referring to FIG. 2 a USB system 10b differs from the USB system 10a of FIG. 1 in that the first data channel 180 in a composite USB cable 170b is connected to the SuperSpeed bus 161 through the USB port 152 and the second data channel 190 in the composite USB cable 170b is connected to the non-SuperSpeed bus 163 through the USB port 153. The first and second data channels 180 and 190 of the composite USB cable 170b are respectively connected to the first and second host controller drivers 110 and 120 through the respective USB ports 152 and 153 of the host 100.

In FIGS. 1 and 2, the first USB ID USB_ID1 of the SuperSpeed function 220 the second USB ID USB_ID2 of the non-SuperSpeed function 270 are not identical to each other. Therefore, operating system (OS) in the host 100 regards the SuperSpeed function 220 and the non-SuperSpeed function 270 as different USB devices. Accordingly, the SuperSpeed function 220 and the non-SuperSpeed function 270 of the mobile device 200 are simultaneously provided with USB connections to the host 100 through respective first and second data channels 180 and 190 of the composite USB cable 170b, with the first USB connection that is through the first data channel operating at SuperSpeed and the second USB connection that is through the second data channel operating at non-SuperSpeed. Accordingly, the USB systems 10a and 10b may simultaneously use the first and second data channels 180 and 190 of the composite USB cables 170a and 170b, and thus bus utilization of the USB systems 10a and 10b may be increased.

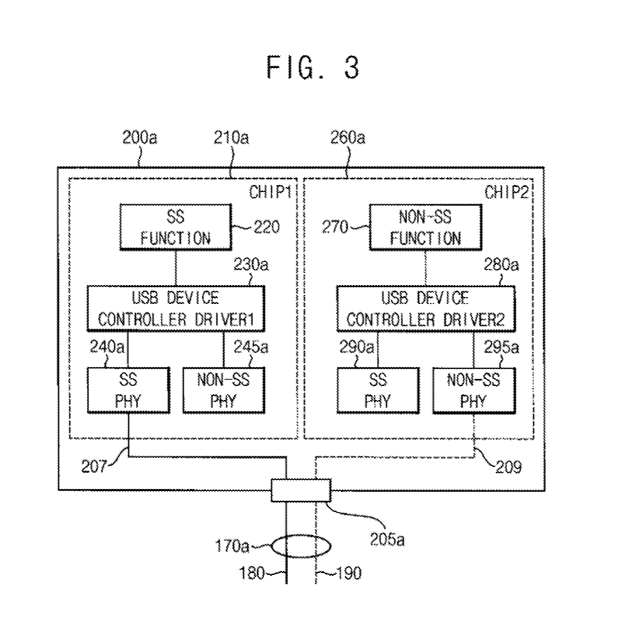

FIG. 3 is a block diagram illustrating an example of the mobile device in FIG. 1 according to an exemplary embodiment.

Referring to FIG. 3, a mobile device 200a may be a two-chip device that includes first and second chips 210a and 260a.

The first chip 210a includes the SuperSpeed function 220, a first device controller driver 230a, a first (SuperSpeed) physical layer (PHY) 240a and a second (non-SuperSpeed) PHY 245a. The first device controller driver 230a converts the SuperSpeed function 220 to data interpretable by the host 100 and provides the converted data to the host 100. The first PHY 240a and the second PHY 245a are connected to the first device controller driver 230a and encodes the converted data and decodes data from the host 100. Since the first chip 210 provides data of the SuperSpeed function 220 to the host 100, the first PHY 240a is enabled and the first PHY 240a is connected to the first data channel 180 through a SuperSpeed bus 207.

The second chip 260a includes the non-SuperSpeed function 270, a second device controller driver 280a, a first (SuperSpeed) PHY 290a and a second (non-SuperSpeed) PHY 295a. The second device controller driver 280a converts the non-SuperSpeed function 270 to data interpretable by the host 100 and provides the converted data to the host 100. The first PHY 290a and the second PHY 295a are connected to the second device controller driver 280a and encodes the converted data or decodes data from the host 100. Since the first chip 210 provides data of the non-SuperSpeed function 270 to the host 100, the second PHY 295a is enabled and the second PHY 290a is connected to the second data channel 190 through a non-SuperSpeed bus 209. Since the first and second data channels 180 and 190 of the composite USB cable 170a are simultaneously used, bus utilization may be increased.

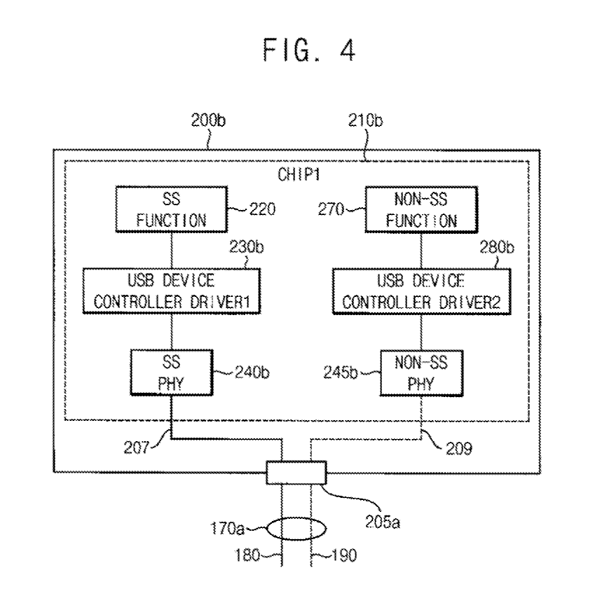

FIG. 4 is a block diagram illustrating an example of the mobile device in FIG. 1 according to an exemplary embodiment.

Referring to FIG. 4, a mobile device 200b includes the SuperSpeed function 220, a first (SuperSpeed) device controller driver 230b, a first (SuperSpeed) PHY 240b, non-SuperSpeed function 270, a second (non-SuperSpeed) device controller driver 280b and a second (non-SuperSpeed) PHY 245b.

The first device controller driver 230b converts the SuperSpeed function 220 to data interpretable by the host 100 and provides the converted data to the host 100. The first PHY 240b is connected to the first device controller driver 230b and encodes the converted data or decodes data from the host 100. The first PHY 240b provides the first data channel 180 with the encoded data with a SuperSpeed connection through the SuperSpeed bus 207.

The second device controller driver 280b converts the non-SuperSpeed function 270 to data interpretable by the host 100 and provides the converted data to the host 100.

The second PHY 245b is connected to the second device controller driver 280b and encodes the converted data or decodes data from the host 100. The second PHY 240b provides the second data channel 190 with the encoded data with a non-SuperSpeed connection through the non-SuperSpeed bus 209.

In an exemplary embodiment of FIG. 3, the first and second chips 210a and 260a have the SuperSpeed function 220 and the non-SuperSpeed function 270 respectively, but in an exemplary embodiment of FIG. 4, the one chip 210b has both the SuperSpeed function 220 and the non-SuperSpeed function 270. However, when the SuperSpeed function 220 and the non-SuperSpeed function 270 have different USB IDs with respect to each other, the OS in the host 100 regards the SuperSpeed function 220 and the non-SuperSpeed function 270 as different USB devices. Since the first and second data channels 180 and 190 of the composite USB cable 170a are simultaneously used, bus utilization may be increased.

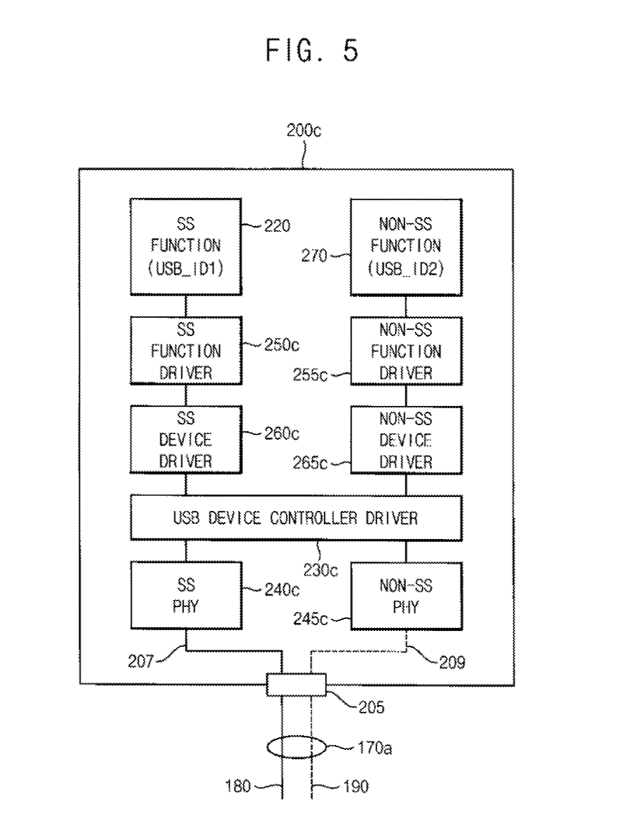

FIG. 5 is a block diagram illustrating an example of the mobile device in FIG. 1 according to an exemplary embodiment.

Referring to FIG. 5, a mobile device 200c includes the SuperSpeed function 220, a first (SuperSpeed) function driver 250c, a first (SuperSpeed) device driver 260c, the non-SuperSpeed function 270, a second (non-SuperSpeed) function driver 255c, a second (non-SuperSpeed) device driver 265c, a device controller driver 230c, a SuperSpeed PHY 240c and a non-SuperSpeed PHY 245c in one chip.

The first function driver 250c drives the SuperSpeed function 220 and the first device driver 260c drives the first function driver 250c. The second function driver 255c drives the non-SuperSpeed function 270 and the second device driver 265c drives the second function driver 255c. The device controller driver 230c converts the SuperSpeed function 220 to data interpretable by the host 100 and provides the converted data to the SuperSpeed PHY 240c and converts the non-SuperSpeed function 270 to data interpretable by the host 100 and provides the converted data to the non-SuperSpeed PHY 245c.

The SuperSpeed PHY 240c is connected to the device controller driver 230c and encodes the converted data or decodes data from the host 100. The first PHY 240c provides the first data channel 180 with the encoded data with a SuperSpeed connection through the SuperSpeed bus 207. The second PHY 245c is connected to the device controller driver 280c and encodes the converted data or decodes data from the host 100. The second PHY 240c provides the second data channel 190 with the encoded data with a non-SuperSpeed connection through the non-SuperSpeed bus 209.

In an exemplary embodiment of FIG. 5, the mobile device 200c includes both the SuperSpeed function 220 and the non-SuperSpeed function 270 in one chip, and the SuperSpeed function 220 and the non-SuperSpeed function 270 are respectively connected to the respective first data channel 180 and the second data channel 190 through the device controller driver 230c and the respective SuperSpeed PHY 240c and non-SuperSpeed PHY 245c. However, when the SuperSpeed function 220 and the non-SuperSpeed function 270 have different USB IDs with respect to each other, the OS in the host 100 regards the SuperSpeed function 220 and the non-SuperSpeed function 270 as different USB devices. Since the first and second data channels 180 and 190 of the composite USB cable 170a are simultaneously used, bus utilization may be increased.

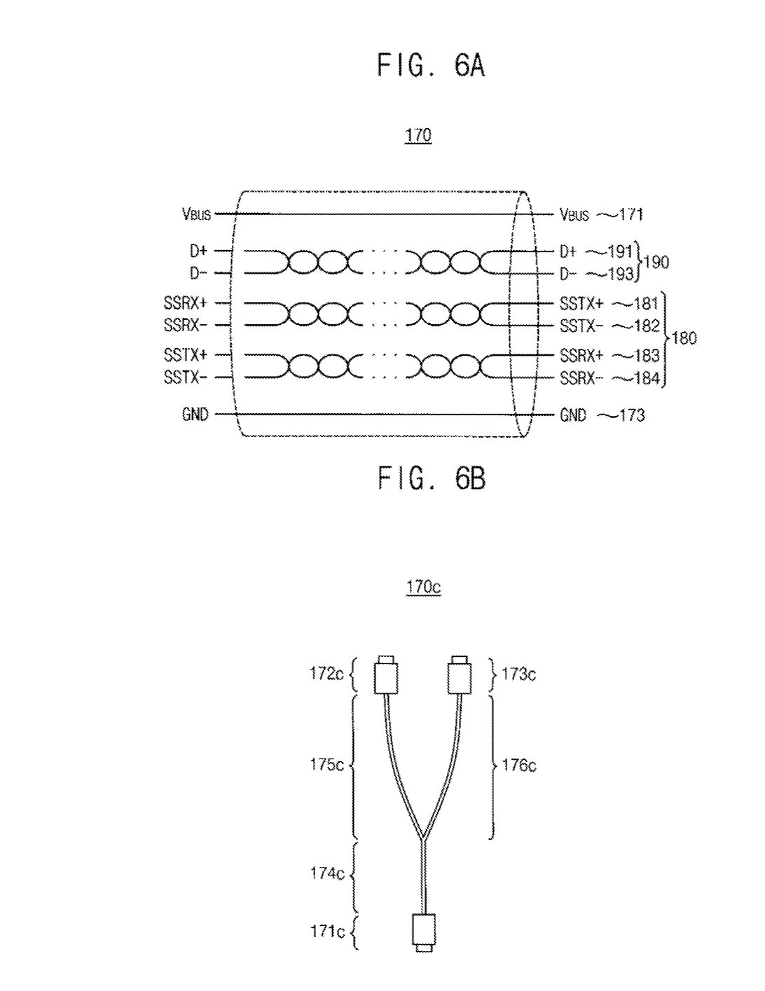

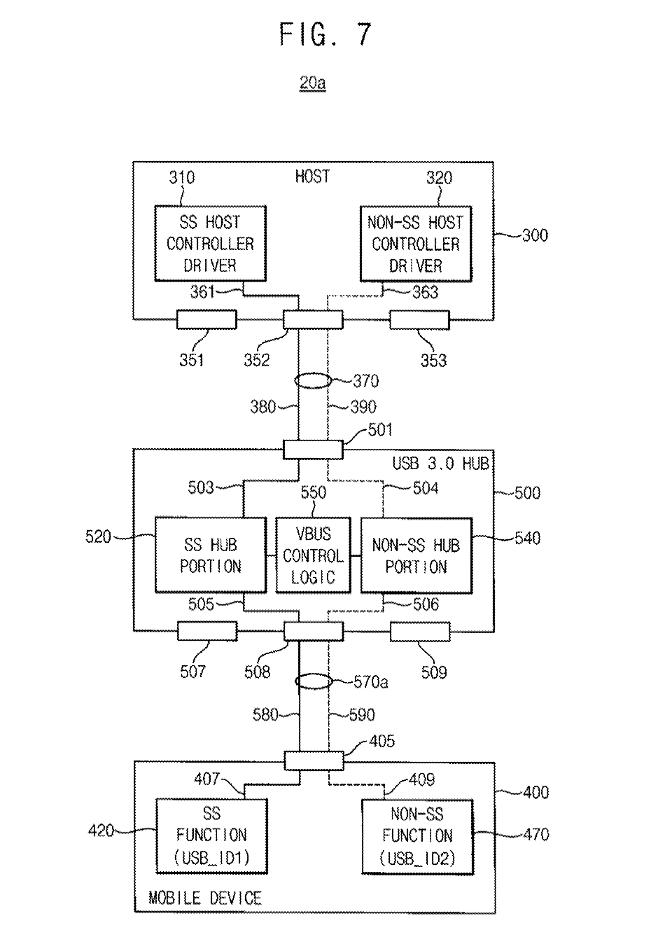

FIG. 6 illustrates an electrical configuration of the composite USB cable in FIG. 1 according to an exemplary embodiment.

Referring to FIG. 6, the composite USB cable 170a is a cable according to USB 3.0 and includes eight lines: a voltage line (VBUS) 171, a ground line (GND) 173, a data plus line (D+) 191, a data minus line (D−) 193, a SuperSpeed receiver plus line (SSRX+) 183, a SuperSpeed receiver minus line (SSRX−) 184, a SuperSpeed transmitter plus line (SSTX+) 181 and a SuperSpeed transmitter minus line (SSTX−) 182. The data plus line 191 and the data minus line 193 constitute the second data channel 190 with the non-SuperSpeed. The SuperSpeed receiver plus line 183, the SuperSpeed receiver minus line 184, the SuperSpeed transmitter plus line 181 and the SuperSpeed transmitter minus line 182 constitute the first data channel 180 with the SuperSpeed. The voltage line 171 and the ground line 173 are commonly used in the first data channel 180 and the second data channel 190. The voltage line 171, the ground line 173, the data plus line 191 and the data minus line 193 are the same lines specified in USB 2.0 and provide backwards and forwards compatibility for USB 2.0 devices and peripherals. The first data channel 180 with a SuperSpeed includes the SuperSpeed receiver plus line 183, the SuperSpeed receiver minus line 184, the SuperSpeed transmitter plus line 181 and the SuperSpeed transmitter minus line 182 and may provide bi-directional data communication at a SuperSpeed between the host 100 and the mobile device 200.

FIG. 6B illustrates a configuration of Y-shaped USB cable according to an exemplary embodiment of the present inventive concept.

Referring to FIG. 6B, a Y-shaped USB cable 170c includes first through third connectors 171c, 172c and 173c, a composite cable portion 174c, a SuperSpeed cable portion 175c and a non-SuperSpeed cable portion 176c. The first connector 171c is connected with the composite cable portion 174c, the second connector 172c is connected with the SuperSpeed cable portion 175c and the third connector 173c is connected with the non-SuperSpeed cable portion 176c. The SuperSpeed cable portion 175c and the non-SuperSpeed cable portion 176c are connected with the composite cable portion 174c with Y-shape.

The composite USB cable 170b in FIG. 2 may employ the Y-shaped USB cable 170c. That is, the first connector 171c may be connected to the USB port 205 of the mobile device 200, the second connector 172c may be connected to the USB port 152 of the host 100 and the third connector 173c is connected to the USB port 153 of the host 100. The composite cable portion 174c may include the first and second data channels 180 and 190 of the composite USB cable 170b, the SuperSpeed cable portion 175c may include the first data channel and the non-SuperSpeed cable portion 176c may include the second data channel.

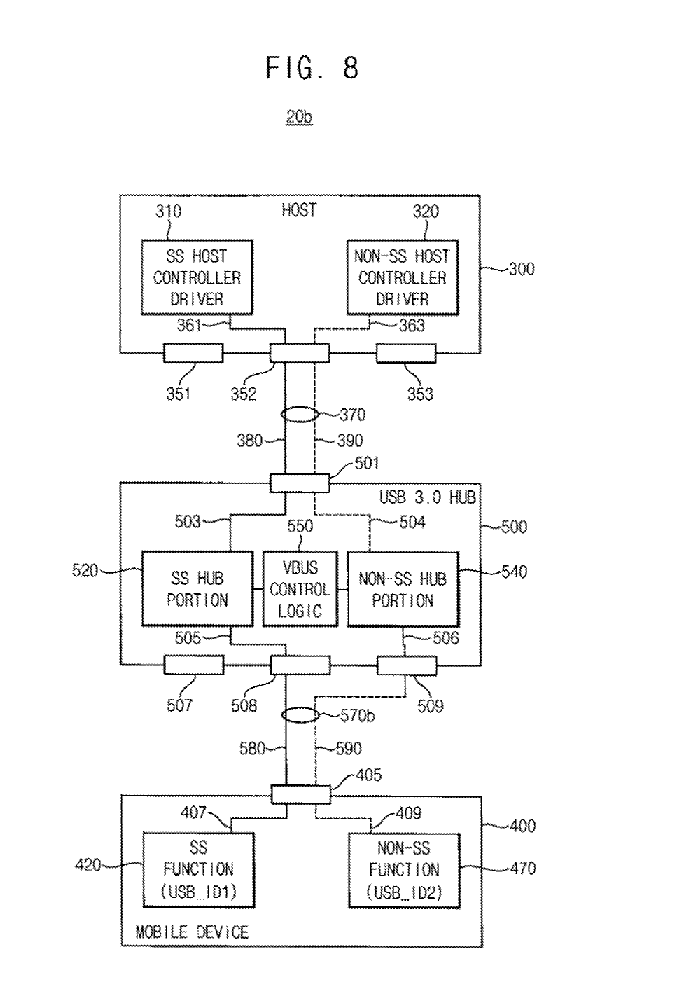

FIG. 7 is a block diagram illustrating an example of a USB system including a USB hub according to an exemplary embodiment.

Referring to FIG. 7, a USB system 20a includes a host 300, a mobile device 400, a USB hub 500, a first composite USB cable 370 that connects the host 300 and the USB hub 500 and a second composite USB cable 570a that connects the USB hub 500 and the mobile device 400.

The host 300 includes a first (SuperSpeed) host controller driver 310, a second (non-SuperSpeed) host controller driver 320 and a plurality of USB ports 351, 352 and 353. The mobile device 400 may include a first USB function 420, a second USB function 470 and a USB port 405. The first USB function 420 may be a SuperSpeed USB function, and a second USB function 470 may be a non-SuperSpeed USB function. The SuperSpeed USB function 420 has a first USB identifier (ID) USB_ID1 and the non-SuperSpeed USB function 470 has a second USB ID USB_ID2. The USB hub 500 is connected to the host 300 through the first composite USB cable 370, and is connected to the mobile device 400 through the second composite USB cable 570a. Electrical interface between the host 300 and the mobile device 400 is therefore provided via the two composite USB cables 370, 570a and the USB hub 500.

The USB hub 500 includes a first (SuperSpeed) hub portion 520, a second (non-SuperSpeed) hub portion 540 and a voltage control logic 550. The first and second hub portions 520 and 540 operate independently on separate data busses. The USB hub 500 is connected to the first composite USB cable 370 through one upstream port 501 and is connected to the second composite USB cable 570a through at least one of a plurality of downstream ports 507, 508 and 509. The first hub portion 520 is connected to a first data channel 380 in the first composite USB cable 370 through a SuperSpeed bus 503, and is connected to a first data channel 580 in the second composite USB cable 570a through a SuperSpeed bus 505. In addition, the second hub portion 540 is connected to a second data channel 390 in the first composite USB cable 370 through a non-SuperSpeed bus 504 and is connected to a second data channel 590 in the second composite USB cable 570a through a non-SuperSpeed bus 506.

Therefore, the first hub portion 520 provides a first electrical interface having a first speed (SuperSpeed) between the first host controller driver 310 and the first function 420, and the second hub portion 540 provides a second electrical interface having a second speed (non-SuperSpeed) between the second host controller driver 320 and the second function 470. Therefore, the first speed is greater than the second speed. The USB hub 500 may simultaneously provide the first and second electrical interfaces between the host 300 and the mobile device 400 depending on whether the first USB ID USB_ID1 of the first function 420 and the second USB ID USB_ID2 of the second function 470 are identical to each other. For example, if the USB IDs are not identical then simultaneous communication through both interfaces is provided but if the USB IDs are identical then simultaneous communication through both interfaces is not provided.

The voltage control logic 550 operates to control the voltage and inrush current to the first hub portion 520 and the second hub portion 540. The voltage control logic 550 may be implemented with hardware, software and/or a combination thereof.

The second composite USB cable 570a is connected to the first and second hub portions 520 and 540 through the downstream port 508 of the downstream ports 507, 508 and 509.

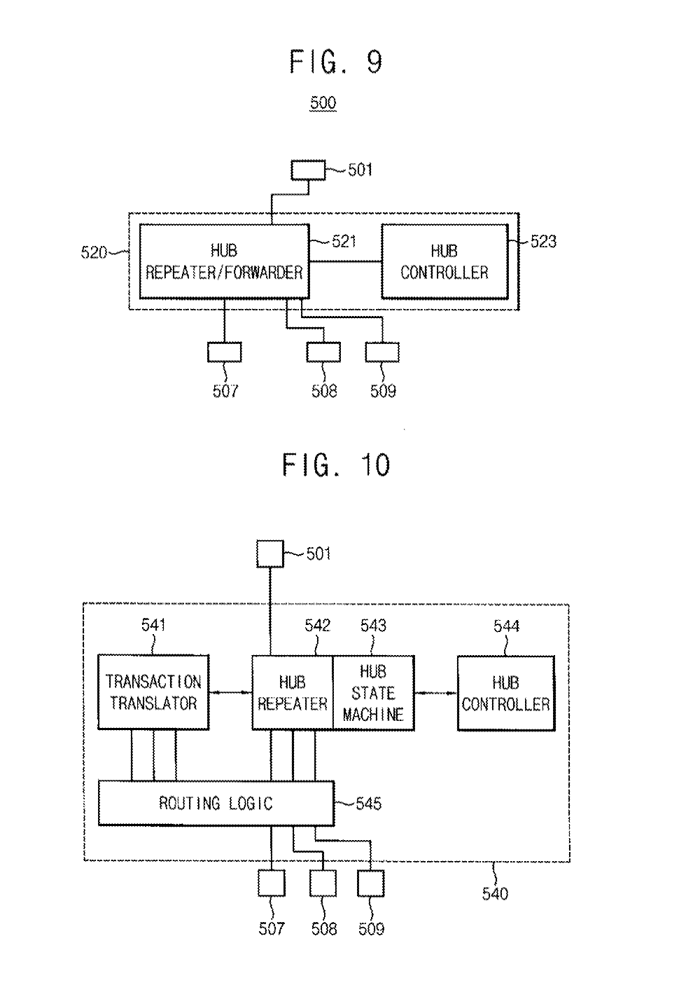

FIG. 8 is a block diagram illustrating an example of a USB system including a USB hub according to an exemplary embodiment.

Referring to FIG. 8 a USB system 20b differs from the USB system 10b of FIG. 7 in that the first data channel 580 in the second composite USB cable 570b is connected to the first hub portion 520 through the downstream port 508 and the second data channel 590 in the second composite USB cable 570b is connected to the second hub portion 540 through the downstream port 509. The first and second data channels 580 and 590 of the second composite USB cable 570b are respectively connected to the first and second hub portions 520 and 540 through the respective downstream ports 508 and 509 of the USB hub 500. The second composite USB cable 570b may employ the Y-shaped USB cable 170c of FIG. 6B.

In FIGS. 7 and 8, the first USB ID USB_ID1 of the SuperSpeed function 420 the second USB ID USB_ID2 of the non-SuperSpeed function 470 are not identical to each other. Therefore, operating system (OS) in the host 300 regards the SuperSpeed function 420 and the non-SuperSpeed function 470 as different USB devices. Accordingly, USB connections for the SuperSpeed function 420 and the non-SuperSpeed function 470 of the mobile device 400 are simultaneously maintained to the host 300 through respective first and second data channels 380 and 390 of the first composite USB cable 370 and the first and second data channels 580 and 590 of the second composite USB cable 570a or 570b with respective SuperSpeed and non-SuperSpeed. The USB systems 20a and 20b may simultaneously use the first and second data channels 380 and 390 of the first composite USB cables 370 and the first and second data channels 580 and 590 of the second composite USB cables 570, and thus bus utilization of the USB systems 20a and 20b may be increased.

The mobile device 400 in FIGS. 7 and 8 may be one of the mobile devices 200a, 200b and 200c of FIGS. 3 through 5.

In addition, when the first function 420 and the second function 470 in FIG. 8 are included respectively in two devices that are physically separate, the first function 420 may be connected to the first hub portion 520 through the first data channel 580 and the downstream port 508. In addition, the second function 470 may be connected to the second hub portion 540 through additional composite USB cable of a USB 2.0 cable and the downstream port 509.

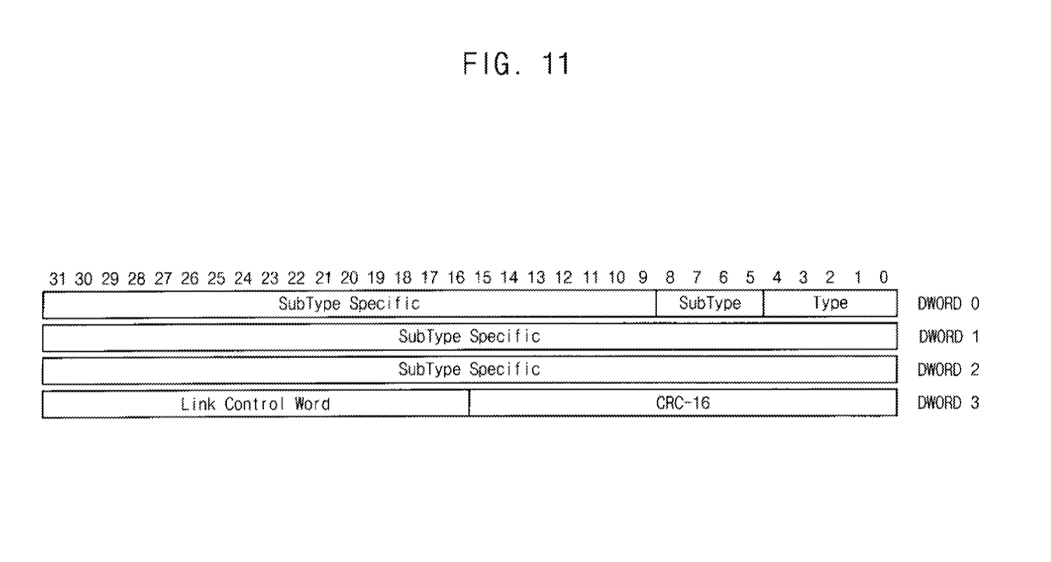

FIG. 9 is a block diagram illustrating the first hub portion of a hub 500 in FIG. 7 according to an exemplary embodiment.

Referring to FIG. 9, the first hub portion 520 of the hub 500 includes a hub repeater/forwarder 521 and a hub controller 523. The hub repeater/forwarder 521 manages connectivity between upstream 501 and downstream ports 507, 508 and 509. The hub controller 523 includes a logic that controls communication between the host 300 and the first hub portion 520. The hub controller 523 provides status and control and permits the host 300 to access the first hub portion 520.

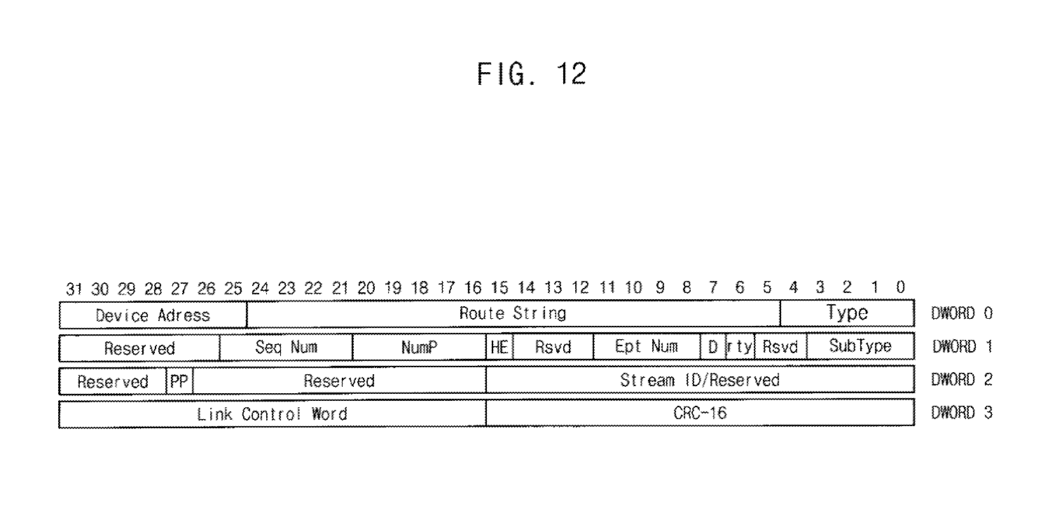

FIG. 10 is a block diagram illustrating an example of the second hub portion in FIG. 7 according to an exemplary embodiment.

Referring to FIG. 10, the second hub portion 540 includes a transaction translator 541, a hub repeater 542, a hub state machine 543, a hub controller 544 and a routing logic module 545. The second hub portion 540 is connected to the host 300 through the upstream port 501, and is connected to the mobile device 400 through at least one of the downstream ports 507, 508 and 509.

The hub repeater 542 is utilized for connectivity setup and teardown. The hub repeater 542 also supports exception handling such as, for example, bus fault detection and recovery and connect/disconnect detection. The hub controller 544 provides the mechanism for host-to-hub communication. The transaction translator 541 responds to high-speed split transactions and translates them to full-/low-speed transactions with full-/low-speed devices attached on downstream ports 507, 508 and 509. The operating speed of the second hub portion 540 is the same, or substantially the same as the operating speed of the upstream port 501. The transaction translator 541 takes high-speed split transactions and translates them to full-/low-speed transactions. The hub controller 544 provides status and control functions, and permits host access to the second hub portion 540. The operating speed of a device attached on the downstream ports 507, 508 and 509 determines whether the routing logic module 545 connects a port to the transaction translator 541 or the hub repeater 542.

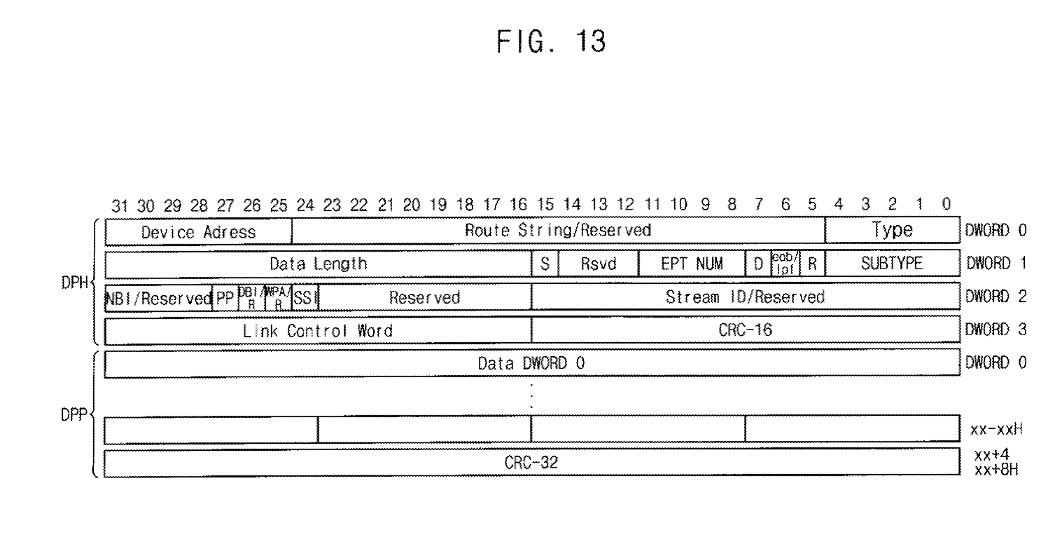

FIGS. 11 through 14 illustrate examples of packets used in SuperSpeed transaction that occurs between the host and the mobile device.

All packets used in SuperSpeed transaction includes a 14-byte header, followed by a 2 byte Link Control Word at the end of the packet (16 bytes total).

FIG. 11 illustrates an example of a transaction packet used in SuperSpeed transaction that occurs between the host and the mobile device.

Transaction packets traverse all the links directly connecting the host to a mobile device. The transaction packets are used to control the flow of data packets and to manage end-to end connection.

FIG. 12 illustrates an example of a link management packet used in SuperSpeed transaction that occurs between the host and the mobile device.

Link management packets are used to manage a single link. The link management packets carry no addressing information and as such are not routable. The link management packets may be generated as the result of hub port commands.

FIG. 13 illustrates an example of a data packet used in SuperSpeed transaction that occurs between the host and the mobile device.

Data packets can be sent by either the host or the mobile device. The host uses the data packets to send data to a mobile device. The mobile device uses the data packet to return data to the host in response to an ACK transaction packet. All data packets include a data packet header (DPH) and a data packet payload (DPP). The data packets traverse the direct data path between the host and a mobile device.

FIG. 14 illustrates an example of an isochronous timestamp packet used in SuperSpeed transaction that occurs between the host and the mobile device.

Isochronous timestamp packets (ITPs) are used to deliver timestamps from the host to all active mobile devices. ITPs carry no addressing or routing information and are multicast by hubs to all of their downstream ports. The ITPs are used to provide host timing information to mobile devices for synchronization.

The packets of FIGS. 11 through 14 are used when the first host controller driver 110, the first hub portion 520 and the SuperSpeed function 420 USB communicate with each other through the first data channels 380 and 580 at a SuperSpeed in FIG. 7. In addition, the packets of FIGS. 11 through 14 are used when the first host controller driver 310 and the SuperSpeed function 220 USB communicate with each other through the first data channel 180 at a SuperSpeed in FIG. 1.

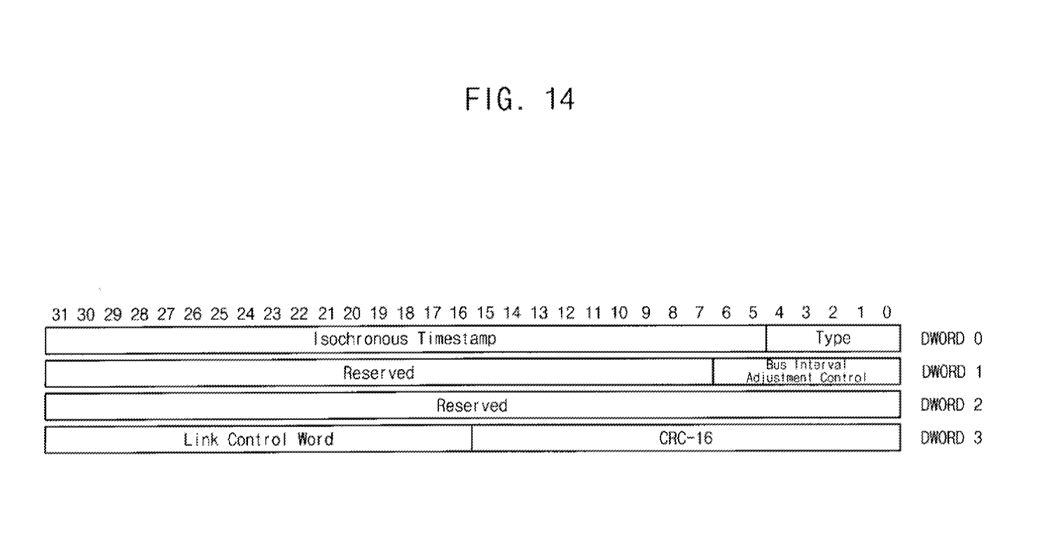

FIG. 15 is a flow chart illustrating a connection method of a USB system according to an exemplary embodiment.

Referring to FIGS. 1 and 15, when the mobile device 200 including the SuperSpeed function 220 and the non-SuperSpeed function 270 is connected to the host 100 through the composite USB cable 170a, the first host controller driver 110 detects (checks) whether the mobile device 200 includes the SuperSpeed function 220 (S610). The second host controller driver 120 detects (checks) whether the mobile device 200 includes the non-SuperSpeed function 270 (S620). Detection of the SuperSpeed function 220 and the non-SuperSpeed function 270 may be simultaneously performed by the first host controller driver 110 and the second host controller driver 120 respectively. At least one of SuperSpeed connection and non-SuperSpeed connection is provided to the host 100 and the mobile device 200 based on whether the first USB ID of the SuperSpeed function 220 and the second USB ID of the non-SuperSpeed function 270 are identical with respect to each other (S630, S640 and S650).

For providing at least one of SuperSpeed connection and non-SuperSpeed connection to the host 100 and the mobile device 200, it is determined whether the first USB ID of the SuperSpeed function 220 and the second USB ID of the non-SuperSpeed function 270 are identical with respect to each other (S630). When the first USB ID of the SuperSpeed function 220 and the second USB ID of the non-SuperSpeed function 270 are not identical to each other (No, S630), the OS in the host 100 regards the SuperSpeed function 220 and the non-SuperSpeed function 270 as different USB devices. Accordingly, USB connections to the SuperSpeed function 220 and the non-SuperSpeed function 270 of the mobile device 200 are simultaneously maintained to the host 100 (S640). When the first USB ID of the SuperSpeed function 220 and the second USB ID of the non-SuperSpeed function 270 are identical to each other (Yes, S630), the OS in the host 100 regards the SuperSpeed function 220 and the non-SuperSpeed function 270 as same USB device. Accordingly, either the SuperSpeed function 220 or the non-SuperSpeed function 270 of the mobile device 200 is connected to the host 100 (S650). Superspeed connection may be provided through the first data channel (data bus) 180 and the non-SuperSpeed connection may be provided through the second data channel 190. Therefore, bus utilization may be increased by simultaneously providing SuperSpeed connection and non-SuperSpeed connection to the host 100 and the mobile device 200 using the first and second data channels 180 and 190 of the composite USB cable 170a.

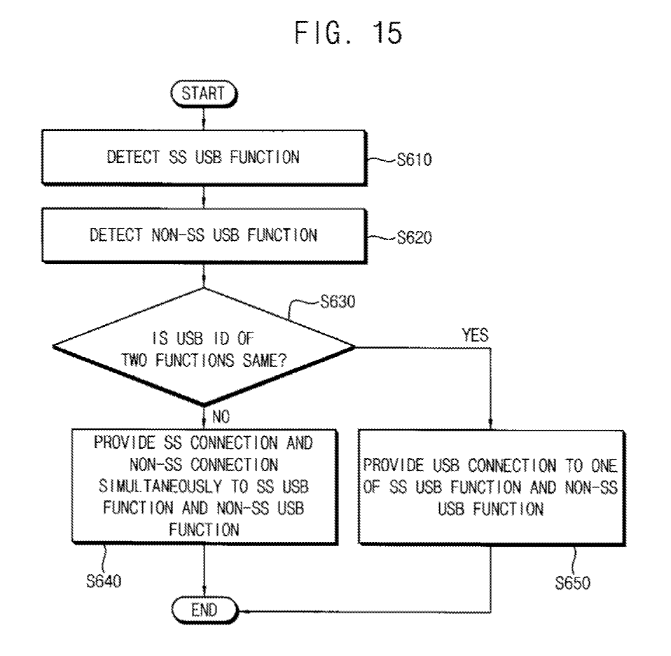

FIG. 16 is a block diagram illustrating an example of a USB system according to an exemplary embodiment.

Referring to FIG. 16, a USB system 800 includes a USB enabled host 810, such as a computer or laptop having at least one USB port. The USB system 800 also includes a USB device 850. The host 810 is connected to a host wire adapter (HWA) 840 through a composite USB cable 837 connected to a USB port 835. The HWA 840 provides the host with wireless ultra-wideband (WUSB) functionality.

The host 110 includes a HWA driver 827 that provides software that facilitates communication involving the HWA 840. In addition, the host 810 includes a SuperSpeed host controller driver 823 and a non-SuperSpeed host controller driver 825. The HWA 840 includes a wireless transceiver 843. The HWA 840 uses the transceiver 843 to communicate wirelessly with a device wire adapter (DWA) 890 over a wireless link. For example, the HWA 840 communicates with the DWA 890 using the WUSB protocol. The wireless link is established over an ultra-wideband (UWB) spectrum. A first data channel 838 with a SuperSpeed in the composite USB cable 837 is connected to the SuperSpeed host controller driver 823 through a SuperSpeed bus 831, and a second data channel 839 with a non-SuperSpeed in the composite USB cable 837 is connected to the non-SuperSpeed host controller driver 825 through a non-SuperSpeed bus 833.

The host 810 further includes a DWA driver 821 that facilitates communication involving the DWA 890. The DWA 890 has a wireless transceiver 893 that is used to communicate with the HWA 840 via the HWA transceiver 843. The DWA 890 is connected to a USB enabled device 850 having a SuperSpeed function 861 and a non-SuperSpeed USB function 873 through a composite USB cable 887. The composite USB cable 887 is connected to a USB port 885 of the USB enabled device 850. The USB enabled device 850 further includes a SuperSpeed device driver 871, a non-SuperSpeed device driver 873, a SuperSpeed PHY 875 and a non-SuperSpeed PHY 877. A first data channel 888 with a SuperSpeed in the composite USB cable 887 is connected to the SuperSpeed function 861 through a SuperSpeed bus 881, and a second data channel 889 with a non-SuperSpeed in the composite USB cable 887 is connected to the non-SuperSpeed function 863 through a non-SuperSpeed bus 883.

Therefore, WUSB connection is established between the DWA 890 and the HWA 840, SuperSpeed USB connection is provided through the first data channel 888 between the SuperSpeed Function 861 of the USB enabled device 850 and the DWA 890, and non-SuperSpeed USB connection is provided through the second data channel 889 between the non-SuperSpeed Function 863 of the USB enabled device 850 and the DWA 890. When the SuperSpeed Function 861 and the non-SuperSpeed Function 863 have different USB IDs with respect to each other, the SuperSpeed USB connection and the non-SuperSpeed USB connection may be simultaneously provided, and thus bus utilization of the USB system 800 may be increased.

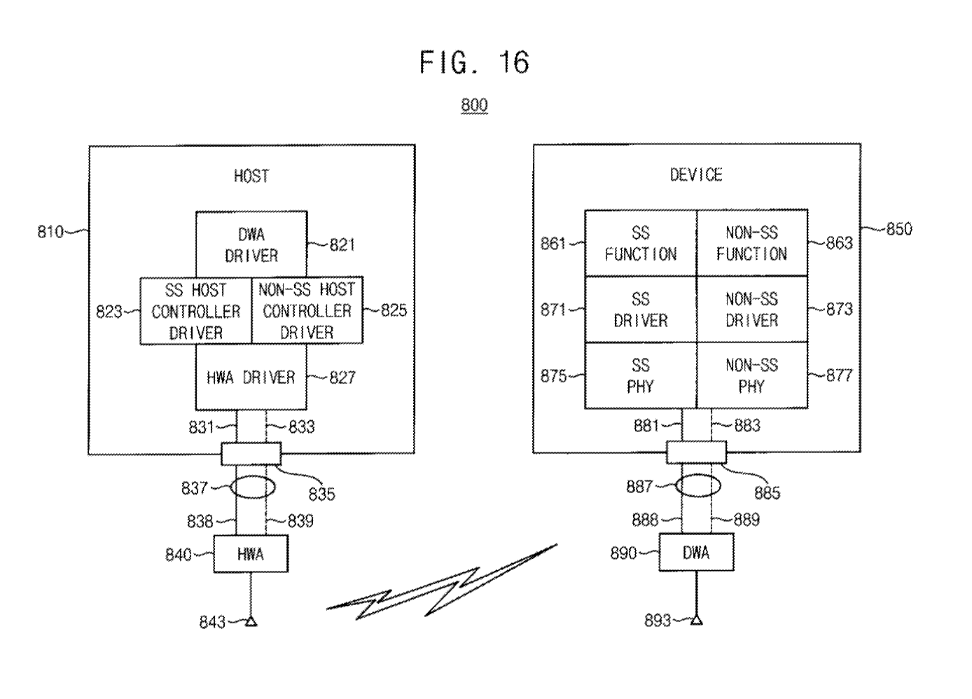

FIG. 17 is a block diagram illustrating an example of a USB system according to an exemplary embodiment.

Referring to FIG. 17, a USB system 900 includes a USB host 910 and a USB device 920. The USB host 910 and the USB device 920 have configurations which are able to communicate through USB and WUSB, respectively.

The USB host 910 includes an internal circuit 911, a WUSB interface 912, an antenna 913, and a USB connector port 914. The internal circuit 911 is configured to perform the functionality of the USB host 910. For example, when the host 910 is a personal computer, the internal circuit 911 may include a processor, a memory, a memory controller, a buffer, a clock generator, input/output device, and the like. The WUSB interface 912 provides an interface that enables the internal circuit 911 and the USB device 920 to conduct WUSB communication by means of antennas 913 and 923, and/or USB communication by means of connector ports 914 and 924, respectively.

The USB device 920 includes an internal circuit 921, a WUSB interface 922, an antenna 923, and a USB connector port 924. The internal circuit 921 is configured to perform the functionality of the USB host 910. For example, when the USB device 920 is a digital camera, the internal circuit 921 may include a processor, a memory, a memory controller, a Digital Signal Processor (DSP), a buffer, a clock generator, an input/output device, and the like. The WUSB interface 922 provides an interface that enables the internal circuit 911 and the USB device 920 to conduct WUSB communication by means of antennas 913 and 923, and/or USB communication by means of connectors 914 and 924. The USB device 920 may include one or more portable devices, such as a personal digital assistant (PDA), MP3 player, portable video game console, memory stick, and the like, or one or more computer peripheral devices, such as mouse, keyboard, printer, scanner, game controller/joystick, card reader, and the like.

In accordance with the USB system 900, at an initial association between the USB host 910 and the USB device 920, WUSB communication is conducted by connecting the USB connector 914 of the USB host 910 and the USB connector 924 of the USB device 920, exchanging connection context (CC) by means of USB communication, and disconnecting the connectors 914 and 924. The configuration of the USB host 910 and the USB device 920 enables WUSB/USB communication without using a separate wire adapter, and is readily able to perform association.

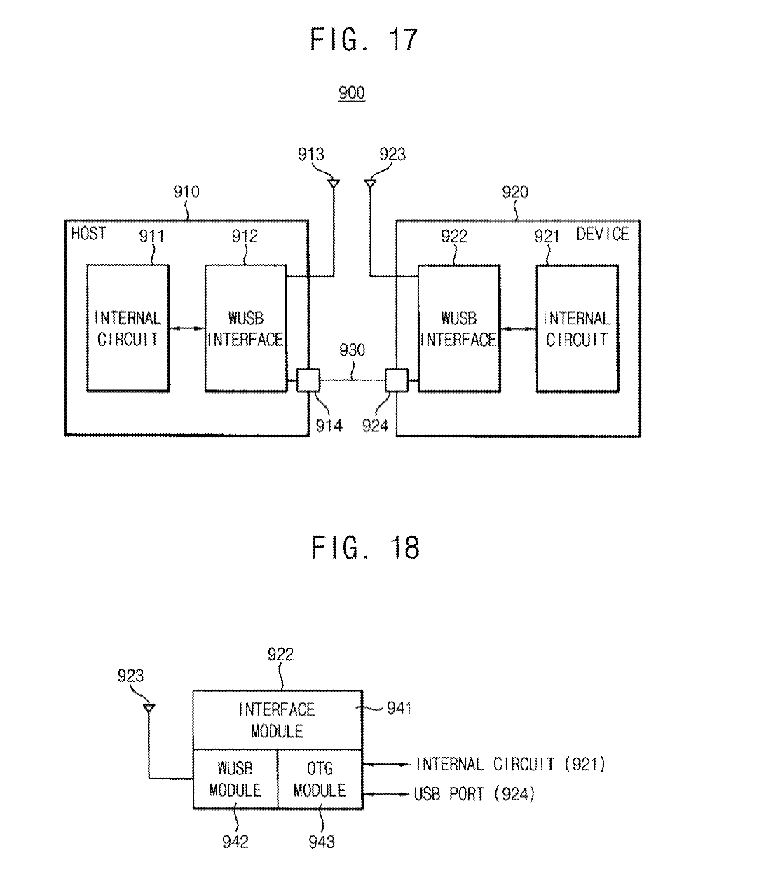

FIG. 18 is a block diagram illustrating a configuration of the WUSB interface of FIG. 17 according to an exemplary embodiment.

Referring to FIG. 18, the WUSB interface 922 includes an interface module 941, a WUSB module 942, and an on-the-go (OTG) module 943.

The WUSB module 942 interfaces for WUSB communication between the internal circuit 921 of FIG. 17 and an external device, such as the host 910. The OTG module 943 controls the USB communication between the internal circuit 921 and the external device. The interface module 941 controls the WUSB module 942 and the OTG module 943 to perform a control function for smooth WUSB/USB communication between the internal circuit 921 and the external device.

As portable devices, such as PDAs (personal digital assistants), MP3 players, cellular phones, portable video game consoles, and the like, become more prevalent, there is increasing demand for direct connection between such devices without using a personal computer. OTG-supplementation provides limited-host functionality to these portable devices to satisfy such demand. The OTG module 943 enables data transfer between peripheral devices, between a peripheral device and a portable device, or between portable devices, without using a separate host.

When the USB device 920 is connected with the host 910 by means of the USB connector 924, the host 910 and the OTG interface 943 have a “host-device” relationship. Also, when the USB device 920 is connected with the host 910 by means of the USB connector 924, or when the USB device 920 communicates through WUSB with the host 910 by means of the antenna 923, the OTG interface 943 and the internal circuit 921 of the USB device 920 have a “host-device” relationship. The OTG module 943 is therefore designed to operate as either a “host” or a “device,” according to the operation mode.

When the connector 924 of the USB device 920 is connected to the connector 914 of the host 910 for association, the host 920 and the internal circuit 921 in the USB device 920 communicate over a USB connection by means of the OTG module 943. After the association operation is completed, the internal circuit 921 of the USB device 920 communicates using WUSB with the host 910 by means of the antenna 923. Here, the interface module 941 in the WUSB interface 922 controls incoming signals such that a signal received from the antenna 923 is transferred to the internal circuit 921 through the WUSB module 942 and the OTG module 943, in this order. The interface module 941 controls outgoing signals such that a signal output from the internal circuit 921 is transferred to the host 910 through the OTG module 943 and the WUSB module 942, in this order.

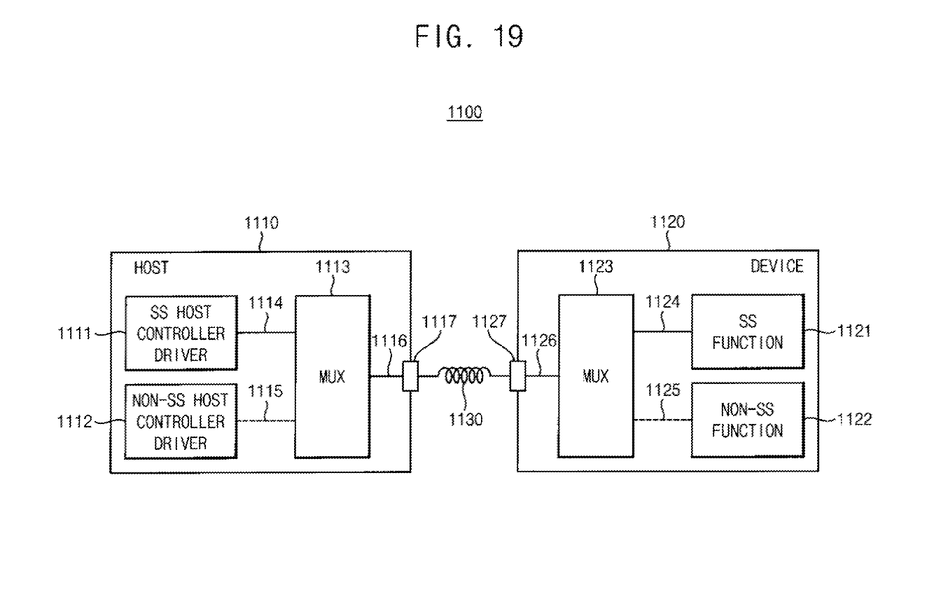

FIG. 19 is a block diagram illustrating an example of a USB system according to an exemplary embodiment.

Referring to FIG. 19, a USB system 1100 includes a host 1110 and a device 1120. The host 1110 and the device 1120 are connected to each other through an optical fiber 1130.

The host 1110 includes a SuperSpeed host controller driver 1111, a non-SuperSpeed host controller driver 1112 and a multiplexer 1113. The SuperSpeed host controller driver 1111 is connected to the multiplexer 1113 through a SuperSpeed bus 1114 and the non-SuperSpeed host controller driver 1112 is connected to the multiplexer 1113 through a non-SuperSpeed bus 1115. The multiplexer 1113 combines signals from the SuperSpeed host controller driver 1111 and the non-SuperSpeed host controller driver 1112 onto optical output to a USB port 1117 through a composite USB cable 1116. The USB port 1117 may include an electrical-to-optical converter and an optical-to-electrical converter.

The device 1120 includes a SuperSpeed function 1121, a non-SuperSpeed function 1122 and a multiplexer 1123. The SuperSpeed function 1121 is connected to the multiplexer 1123 through a SuperSpeed bus 1124 and the non-SuperSpeed function 1122 is connected to the multiplexer 1123 through a non-SuperSpeed bus 1125. The multiplexer 1123 combines signals from the SuperSpeed function 1121 and the non-SuperSpeed function 1122 onto optical output to a USB port 1127 through a composite USB cable 1126. The USB port 1127 may include an electrical-to-optical converter and an optical-to-electrical converter.

The multiplexer 1113 may demultiplex signals received from the multiplexer 1123 into separate components for the SuperSpeed function 1121 and the non-SuperSpeed function 1122 and may provide each component to the SuperSpeed host controller driver 1111 and the non-SuperSpeed host controller driver 1112.

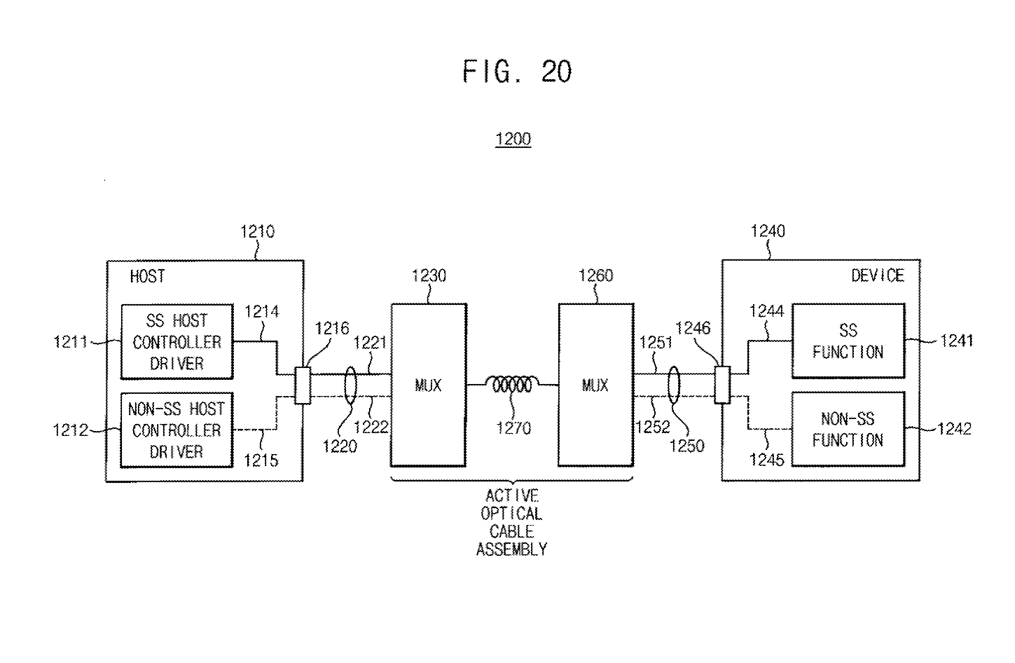

FIG. 20 is a block diagram illustrating an example of a USB system according to an exemplary embodiment.

Referring to FIG. 20, a USB system 1200 includes a host 1210, a device 1240 and multiplexers 1230 and 1260. The multiplexers 1230 and 1260 are connected to each other through an optical fiber 1270 and the multiplexers 1230 and 1260 and the optical fiber 1270 constitutes an active optical cable assembly. The host 1210 is connected to the multiplexer 1230 through a composite USB cable 1220 connected to a USB port 1216 and the device 1240 is connected to the multiplexer 1260 through a composite USB cable 1250 connected to a USB port 1246.

The host 1210 includes a SuperSpeed host controller driver 1211 and a non-SuperSpeed host controller driver 1212. The SuperSpeed host controller driver 1211 is connected to a first data channel 1221 of the composite USB cable 1220 through a SuperSpeed bus 1214 and the non-SuperSpeed host controller driver 1212 is connected to a second data channel 1222 of the composite USB cable 1220 through a non-SuperSpeed bus 1215. The multiplexer 1113 combines signals from the SuperSpeed host controller driver 1211 and the non-SuperSpeed host controller driver 1212 onto optical output to the USB port 1216. The USB port 1212 may include an electrical-to-optical converter and an optical-to-electrical converter.

The device 1240 includes a SuperSpeed function 1241 and a non-SuperSpeed host controller driver 1242. The SuperSpeed function 1241 is connected to a first data channel 1251 of the composite USB cable 1250 through a SuperSpeed bus 1254 and the non-SuperSpeed function 1242 is connected to a second data channel 1252 of the composite USB cable 1250 through a non-SuperSpeed bus 1255. The multiplexer 1260 combines signals from the SuperSpeed function 1241 and the non-SuperSpeed function 1242 onto optical output to the USB port 1246. The USB port 1246 may include an electrical-to-optical converter and an optical-to-electrical converter.

The multiplexer 1230 may demultiplex signals received from the multiplexer 1260 into separate components for the SuperSpeed function 1141 and the non-SuperSpeed function 1142 and may provide each component to the SuperSpeed host controller driver 1211 and the non-SuperSpeed host controller driver 1212.

As described above, according to exemplary embodiments, SuperSpeed connection and non-SuperSpeed connection are simultaneously provided between the host and the mobile device simultaneously using first and second data channels of the composite USB cable. As a result, bus utilization of the USB system may be increased.

The exemplary embodiments may be applied to various mobile applications using composite USB cable.

While the present inventive concept has been particularly shown and described with reference to the exemplary embodiments thereof, it will be understood by those of ordinary skill in the art that various changes in form and detail may be made therein without departing from the spirit and scope of the present invention as defined by the following claims.

What is claimed is:

1. A mobile device, comprising:
a first functional element providing a first function;
a second functional element providing a second function; and
a first universal serial bus (USB) port,
wherein the first functional element and the second functional element are respectively connected to a first host controller driver and a second controller driver in a host through a composite USB cable that connects the first USB port of the mobile device and one or more second USB ports of the host and the mobile device simultaneously provides a USB interconnection to the first and second functional elements depending upon whether a first USB identifier (ID) of the first function and a second USB ID of the second function are identical to each other.

2. The mobile device of claim 1, wherein the composite USB cable comprises:
a first data channel that provides a USB connection between the first function and the first host controller driver at a first speed; and
a second data channel that provides a USB connection between the second function and the second host controller driver at a second speed, the first speed being greater than the second speed.

3. The mobile device of claim 2, wherein the composite USB cable is connected to the first and second host controller drivers through only one of the one or more second USB ports of the host.

4. The mobile device of claim 2, wherein the composite USB cable is connected to the first and second host controller drivers through exactly two of the one or more second USB ports of the host.

5. The mobile device of claim 2, wherein the mobile device comprises:
a first chip that includes the first functional element; and
a second chip that includes the second functional element.

6. The mobile device of claim 5, wherein the first chip comprises:
the first functional element;
a first device controller driver that provides the first function to the host;
a first physical layer (PHY) connected to the first device controller driver; and
a second PHY connected to the first controller driver, and wherein the second chip comprises:
the second functional element;
a second device controller driver that provides the second function to the host;
a third PHY connected to the second device controller driver; and
a fourth PHY connected to the second device controller driver.

7. The mobile device of claim 6, wherein the first PHY is connected to the first data channel when the first function is enabled in the first chip and the fourth PHY is connected to the second data channel when the second function is enabled in the second chip.

8. The mobile device of claim 2, wherein the mobile device comprises one chip that includes both the first functional element and the second functional element.

9. The mobile device of claim 8, wherein the one chip further comprises:
a first device controller driver that provides the first function to the host;
a first physical layer (PHY) that connects the first device controller driver to the first data channel;
a second device controller driver that provides the second function to the host; and
a second PHY that connects the second device controller driver to the second data channel.

10. The mobile device of claim 8, wherein the one chip further comprises:
a first function driver that drives the first functional element;
a first device driver connected to the first function driver;
a second function driver that drives the second functional element;
a second device driver connected to the second function driver;
a device controller driver, connected to the first and second device drivers, the device controller driver providing the first function and the second function to the host;
a first physical layer (PHY) that connects the device controller driver to the first data channel; and
a second PHY that connects the device controller driver to the second data channel.

11. The mobile device of claim 1, wherein the first functional element is a multi-media device or a mass storage device and the second functional element is a modem or a human interface device.

12. A universal serial bus (USB) hub, comprising:
a first hub portion configured to provide a first electrical interface at a first speed between a first functional element of a mobile device and a first host controller driver of a host; and
a second hub portion configured to provide a second electrical interface at a second speed between a second functional element of the mobile device and a second host controller driver of the host, wherein the USB hub is respectively connected to the host and the mobile device through a first USB cable and a second USB cable and the USB hub simultaneously provides the first and second electrical interfaces depending upon whether a first USB identity (ID) of the first function and a second USB ID of the second function are identical to each other.

13. The USB hub of claim 12, wherein the first hub portion comprises:
a hub repeater/forwarder configured to manage a connection between downstream ports operating at the first speed and an upstream port; and
a hub controller configured to control communication with the host.

14. The USB hub of claim 12, wherein the first composite USB cable comprises:
a first data channel that establishes a USB connection between the first host controller driver and the first hub portion at the first speed through an upstream port of the USB hub; and
a second data channel that establishes a USB connection between the second host controller driver and the second hub portion at the second speed through the upstream port of the USB hub, and wherein the second USB composite cable comprises:
a third data channel that establishes a USB connection between the first function and the first hub portion with the first speed through at least one of downstream ports of the USB hub; and
a fourth data channel that establishes a USB connection between the second function and the second hub portion with the second speed through at least one of downstream ports of the USB hub.

15. The USB hub of claim 12, wherein the second composite USB cable is respectively connected to the first and second hub portions through one or two of a plurality of downstream ports of the USB hub.

16. A method for communicating data across a universal serial bus (USB) connection, comprising:
determining whether a first functional element capable of communicating over a USB 3.0 SuperSpeed connection within a mobile device and a second functional element within the mobile device have an identical USB identifier (ID) and, when it is determined that the first functional element and the second functional element do not have identical USB IDs:
a USB 3.0 SuperSpeed connection is established between the first functional element of the mobile device and a first host controller driver of a host; and
a concurrent non-SuperSpeed connection is established between the second functional element of the mobile device and a second host controller driver of the host,
wherein the USB 3.0 SuperSpeed connection and the concurrent non-SuperSpeed connection utilize a common composite USB cable.

17. The method of claim 16, wherein when it is determined that the first functional element and the second functional element have identical USB IDs:
either the USB 3.0 SuperSpeed connection is established between the first functional element of the mobile device and the first host controller driver of the host; or
the non-SuperSpeed connection is established between the second functional element of the mobile device and the second host controller driver of the host.

18. The method of claim 16, wherein the common composite USB cable is connected, at one end, to a single USB port of the mobile device and the common composite USB cable is connected, at an opposite end, to a single USB port of the host.

19. The method of claim 16, wherein the common composite USB cable is connected, at one end, to a single USB port of the mobile device and the common composite USB cable is connected, at an opposite end, to two USB ports of the host.

20. The method of claim 16, wherein the second functional element is not capable of communicating over a USB 3.0 SuperSpeed connection.
